(19) United States
(12) Patent Application Publication
(10) Pub. No.: US 2012/0119883 A1
(43) Pub. Date: May 17, 2012

(54) RFID READER DEVICE HAVING A READ-ONLY MODE, AND RELATED OPERATING METHODS

(75) Inventor: BENJAMIN J. BEKRITSKY, MODIN (IL)

(73) Assignee: SYMBOL TECHNOLOGIES, INC., HOLTSVILLE, NY (US)

(21) Appl. No.: 12/947,408

(22) Filed: Nov. 16, 2010

(51) Int. Cl. G06K 7/01

(52) U.S. Cl. 340/10.4; 340/10.5; 340/10.1

(57) ABSTRACT

A method of operating a radio frequency identification (RFID) reader device is presented. The method begins by operating the RFID reader device in a read-only mode, during which the RFID reader device does not generate tag interrogation signals. The method continues by receiving a tag response signal generated from an RFID tag being interrogated by an interrogator device that is distinct and separate from the RFID reader device. The tag response signal is received by the RFID reader device while it is operating in the read-only mode. The method continues by determining a location of the RFID tag, wherein the location is determined based at least in part on information associated with the received tag response signal.

### TECHNICAL FIELD

Embodiments of the subject matter described herein relate generally to radio frequency identification (RFID). More particularly, embodiments of the subject matter relate to an RFID reader device that can be operated in a read-only mode to receive RFID tag response signals generated in response to interrogation by a different interrogator device.

### BACKGROUND

RFID systems and their basic operating principles are well known. RFID systems employ fixed (stationary) RFID readers and/or portable RFID readers, both of which can be used to interrogate RFID tags associated with products, containers, or any items of interest. A traditional RFID reader interrogates RFID tags, which respond by providing tag data that can be collected, interpreted, displayed, or otherwise processed by the RFID reader. In this regard, traditional RFID readers perform both interrogation and reading functions.

In practice, an RFID reader has a limited interrogation zone. Tags located within the interrogation zone can be adequately energized by the interrogation signals emitted by the RFID reader, and tags located outside the interrogation zone may not be properly energized and/or may not be able to produce a tag response signal having the minimum required signal strength needed for reading. These characteristics are illustrated in FIG. 1, which is a simplified diagram of a conventional RFID system 100 that includes a first RFID reader 102 and a second RFID reader 104. The first RFID reader 102 has a first coverage zone 106 associated therewith, and the second RFID reader 104 has a second coverage zone 108 associated therewith. Even though these two coverage zones 106, 108 overlap somewhat, at least some RFID tags 110 can only be read by the first RFID reader 102, because they are outside of the second coverage zone 108. In this respect, conventional RFID reader coverage is limited by the forward link (interrogation) range.

The interrogation range limitations mentioned above can be undesirable in certain situations. For example, if multiple readers are deployed for purposes of redundancy and/or for determining the location of tags (using, for example, triangulation techniques), then those readers must be densely arranged to ensure that their interrogation zones overlap by at least a minimum amount needed to support the particular application. Unfortunately, an RFID system having a large number of densely arranged readers can be costly to implement, maintain, and operate.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a conventional RFID system that includes two RFID readers having overlapping interrogation coverage areas;

FIG. 2 is a schematic representation of an exemplary embodiment of an RFID system that includes read-only RFID devices;

FIG. 3 is a diagram of an RFID system that includes one conventional RFID reader and one read-only RFID device;

FIG. 4 is a schematic representation of an exemplary RFID reader that switches between a traditional interrogate-and-read mode and a read-only mode;

FIG. 5 is a flow chart that illustrates an exemplary mode switching process that could be performed by an RFID reader device;

FIG. 6 is a flow chart that illustrates an exemplary read-only operation process that could be performed by an RFID system; and

FIG. 7 is a flow chart that illustrates an exemplary tag location determining process that could be performed by an RFID system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Moreover, for the sake of brevity, conventional aspects of RFID system components, RFID tags, data communication, processing of RFID tag data, and other aspects of the systems (and the individual operating components of the systems) may not be described in detail herein.

The subject matter presented here relates to a read-only RFID reader device that is capable of receiving RFID tag response signals being interrogated by a different interrogator device. In other words, the read-only RFID reader device does not generate RFID interrogation or activation signals while it is operating in its read-only mode. In accordance with one embodiment, the RFID reader device exclusively operates in the read-only mode, and it has no native interrogation capabilities. In accordance with another embodiment, the RFID reader device can operate in at least two different modes: (1) a traditional interrogate-and-read mode; and (2) a read-only mode.

An RFID system could include one or more read-only RFID devices cooperating with one or more interrogator devices. In this regard, a dual-mode RFID device operating in its read-and-interrogate mode (rather than its read-only mode) could serve as the interrogator device for one or more RFID reader devices operating in the read-only mode. Read-only RFID devices can be utilized to provide reading redundancy, to extend the reading range of a traditional RFID reader, to determine the location of target RFID tags, and the like. In this regard, one or more read-only RFID devices can concurrently (simultaneously) receive and process a tag response signal generated by an RFID tag that is being interrogated. Concurrent operation in this manner enables the RFID system to gather location-related information in a quick and efficient manner, relative to conventional approaches that rely on sequential interrogation and reading by different interrogator devices.

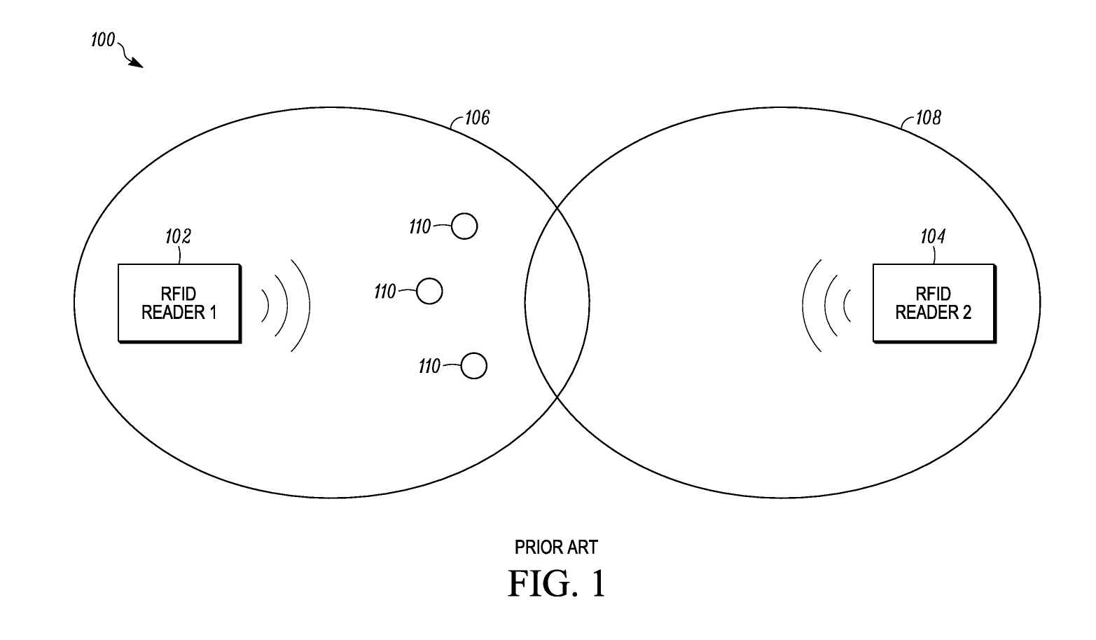

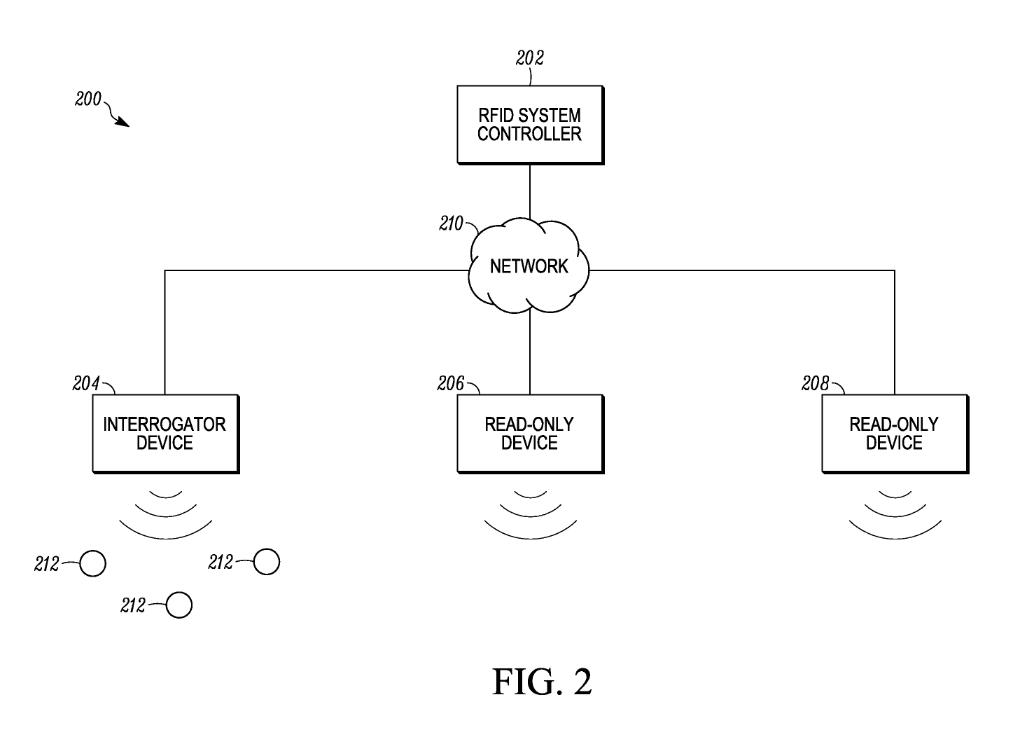

Referring now to the figures, a schematic representation of an exemplary embodiment of an RFID system 200 is shown in FIG. 2. This particular embodiment of the RFID system 200 includes, without limitation: an RFID system controller 202; an RFID interrogator device 204; and two read-only RFID devices 206, 208. As shown in FIG. 2, the interrogator device 204 and each of the read-only RFID devices 206, 208 are physically distinct, separate, and remote devices relative to one another. The RFID system controller 202, the interrogator device 204, and the read-only RFID devices 206, 208 are operatively coupled together using a suitably configured network architecture 210. FIG. 1 also depicts RFID tags 212 as small circles within the interrogation field of the interrogator device 204.

The RFID system 200 may be deployed in any area or location in which RFID reader coverage is desired. For example, the RFID system 200 may be deployed in a warehouse environment, a storage depot environment, a store front, a supermarket, or the like. A component in the RFID system 200 could be a “fixed” or stationary device, or a mobile and portable device. A fixed component would typically be connected to the network architecture 210 using a network cable or other tangible data communication link. On the other hand, a mobile component (such as a handheld reader) could communicate with the RFID system controller 202 using a wireless data communication link, a tangible interface cable, a network cable, a data communication cradle, or the like.

The RFID system controller 202 is deployed when centralized control and management of the RFID system 200 is desired. It should be appreciated that the RFID system controller 202 could be realized as a standalone hardware device, as a software application running on a computer device, as a processing module or other logical construct integrated with a system component having additional functionality, or the like. Indeed, the RFID system controller 202 could be implemented as a standalone piece of hardware in the RFID system 200, or its functionality could be incorporated into any suitable component or device, such as an RFID switch device, a network server component, or the like. For this particular embodiment, the RFID system controller 202 is coupled to (and communicates with) the interrogator device 204 and the read-only RFID devices 206, 208 via the network architecture 210.

When deployed, the RFID system controller 202 may be utilized to control the operation of the interrogator device 204 and the read-only RFID devices 206, 208 to perform centralized collection and processing of RFID tag response signals, to manage data communication between the components of the RFID system 200, to manage data communication between the RFID system 200 and devices or systems external to the RFID system 200, and/or to perform other functions and operations described herein. For example, the RFID system controller 202 might perform the following functions and operations, without limitation: receive and process service requests; translate service requests into commands; dispatch commands to the interrogator device 204; receive tag data from the interrogator device 204 and/or the read-only RFID devices 206, 208; determine the location of an interrogated tag (the geographical location and/or a relative location); and/or determine the distance between an interrogated tag and one or more of the interrogator device 204, the read-only RFID device 206, and the read-only RFID device 208. Of course, the RFID system controller 202 could be suitably configured to perform other functions as needed for the particular system application.

The RFID system controller 202 may be suitably configured and designed to support wireless and/or wired data communication with the interrogator device 204 and the read-only RFID devices 206, 208. In this regard, some or all of the components within the RFID system 200 may support one or more of the following wireless data communication techniques, protocols, and methodologies, without limitation: IrDA (infrared); BLUETOOTH; ZIGBEE (and other variants of the IEEE 802.15 protocol); IEEE 802.11 (any variation); IEEE 802.16 (WiMAX or any other variation); cellular/wireless/cordless telecommunication protocols; satellite data communication protocols; wireless hospital or health care facility network protocols such as those operating in the WMTS bands; and proprietary wireless data communication protocols. Moreover, some of all of the components within the RFID system 200 may support one or more of the following traditional (non-wireless) data communication techniques, protocols, and methodologies, without limitation: Ethernet; home network communication protocols; USB; IEEE 1394 (Firewire); hospital network communication protocols; and proprietary data communication protocols.

FIG. 2 depicts the RFID system controller 202 as a distinct and separate component within the RFID system 200. Alternatively, the functionality of the RFID system controller 202 could be incorporated into one or more of the other components of the RFID system 200, or the functionality could be distributed among a plurality of different components within the RFID system 200. Such a configuration may be desirable to reduce equipment cost and to simplify the system architecture. Thus, an implementation of the RFID system 200 could rely on decentralized control and management of the interrogator device 204 and the read-only RFID devices 206, 208, which could be designed and configured with enhanced functionality and processing intelligence.

The interrogator device 204 is preferably implemented as a traditional RFID reader that generates RFID interrogation signals and receives RFID tag response signals from RFID tags that are located within its interrogation range (such as the RFID tags 212). In this regard, the interrogator device 204 may leverage well known and conventional RFID techniques and technologies related to the generation of RFID interrogation signals and to the receipt, interpretation, and processing of RFID tag response signals. As is well understood, the interrogator device 204 utilizes the traditional RFID over-the-air interface to interrogate tags and to receive tag response signals. Although the interrogator device 204 is preferably realized as a traditional RFID reader, certain embodiments of the RFID system 200 could instead implement an interrogate-only device that lacks the ability to read tag response signals. Such an embodiment could rely on traditional RFID readers and/or the read-only RFID devices 206, 208, which function to read the tag response signals on behalf of the interrogate-only device. Moreover, the interrogator device 204 could be suitably configured to support a read-only mode (as presented here) at certain times, e.g., during periods when it is not actively interrogating tags.

As described in more detail below, a read-only RFID device in the RFID system 200 could be realized as a multimode device or as a strictly read-only device. A multimode device supports at least two different operating modes: (1) an interrogate-and-read mode; and (2) a read-only mode. A multimode device could also support an interrogate-only mode; accordingly, the interrogator device 204 could also function as a read-only RFID device in certain embodiments. In contrast, a strictly read-only device functions only as a tag response receiver. In this regard, a strictly read-only device lacks the ability to interrogate RFID tags, or its interrogation ability has been disabled or deactivated. It should be understood that the term “read-only RFID device” applies to either type of device, particularly when the device is operating in its read-only mode.

For the embodiment depicted in FIG. 2, the interrogator device 204 and the read-only RFID devices 206, 208 can send their received tag data to the RFID system controller 202 for centralized processing and handling, if needed. In certain situations, some pre-processing of received tag data (and/or information associated therewith) might occur before the RFID system controller 202 performs centralized processing and handling.

The network architecture 210 can be realized using any number of physical, virtual, or logical components, including hardware, software, firmware, and/or processing logic configured to support data communication between an originating component and a destination component, where data communication is carried out in accordance with one or more designated communication protocols over one or more designated communication media. For example, the network architecture 210 may include or cooperate with, without limitation: a computer network such as a local area network (LAN) or a wide area network (WAN); a cellular telecommunication network; an 802.11 network (WLAN); an 802.16 network (WiMAX); the Internet; a hospital data communication network (WMTS or other); a control network; the public switched telephone network; a satellite communication network; or the like. In practice, network communications involving a component or an element of the RFID system 200 may be routed using two or more different types of data communication networks using known or proprietary network interfacing techniques.

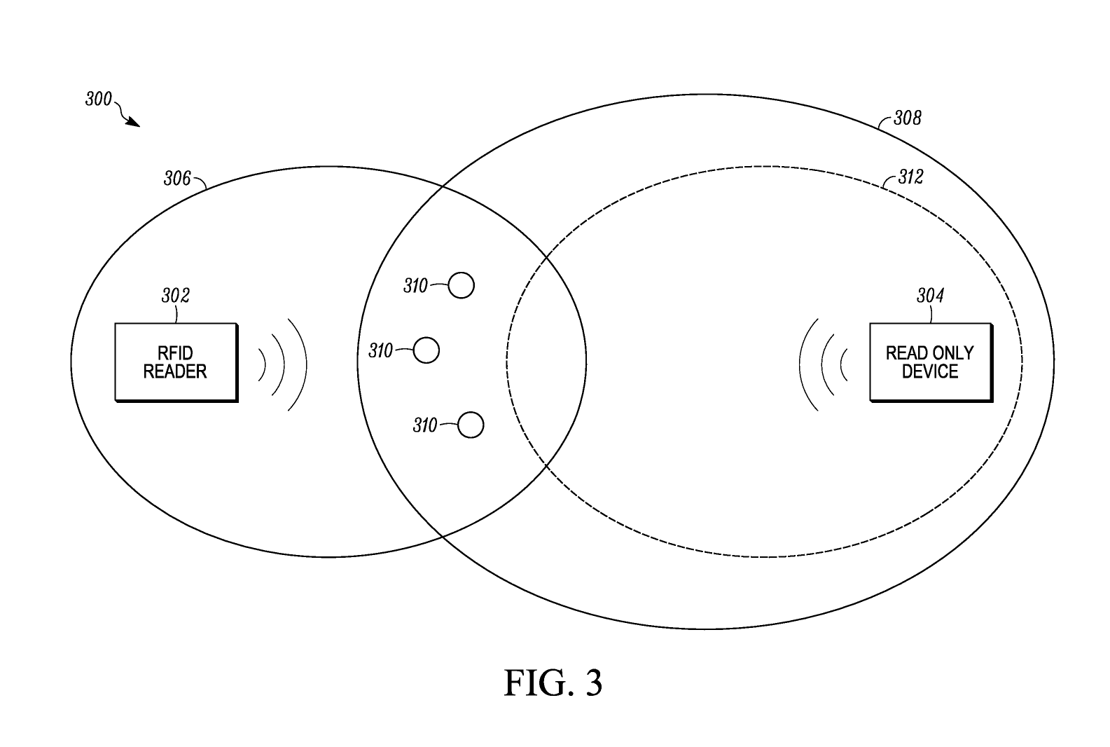

One benefit of using the read-only RFID devices 206, 208 in the RFID system 200 relates to their extended reading range, relative to the typical interrogation range of an interrogator device. In this regard, the interrogation range of a typical RFID reader is less than its reading range. This forward link limitation is due to the minimum interrogation signal strength needed to energize tags, compared to the minimum signal strength needed to read tag response signals. This concept is illustrated in FIG. 3, which is a diagram of an RFID system 300 that includes one conventional RFID reader 302 and one read-only RFID device 304. The RFID reader 302 has an interrogation zone 306 associated therewith, and the read-only RFID reader 304 has a reading zone 308 associated therewith. The RFID tags 310 are located within the interrogation zone 306 of the RFID reader 302. Therefore, the RFID reader 302 can interrogate and read the RFID tags 310 in accordance with conventional methodologies.

Assume, for example, that the read-only RFID device 304 is a multimode device that includes interrogation capabilities. The interrogation zone 312 of the read-only RFID device 304 is depicted in dashed lines. As shown in FIG. 3, the RFID tags 310 are beyond the interrogation zone 312 of the read-only RFID device 304. Thus, the read-only RFID device 304 is unable to perform a traditional interrogate-and-read operation to read the RFID tags 310. Nonetheless, the read-only RFID device 304 can perform a read-only operation to read the RFID tags 310 if the interrogator device 204 provides the interrogation (activation) signal, because the RFID tags 310 are located within the reading zone 308 of the read-only RFID device 304. As depicted in FIG. 3, the reading zone 308 of the read-only RFID device 304 is extended or expanded relative to the interrogation zone 312.

In practice, a plurality of read-only RFID devices can be used to concurrently obtain tag response signals, thus allowing for diversity in capturing responses for tags that might be marginal to the interrogator device. Moreover, if multiple read-only RFID devices are used to simultaneously read a tag response signal generated by a target RFID tag, the RFID system 200 can effectively and efficiently locate the target tag by way of phase, signal strength, beamforming, and other locationing techniques.

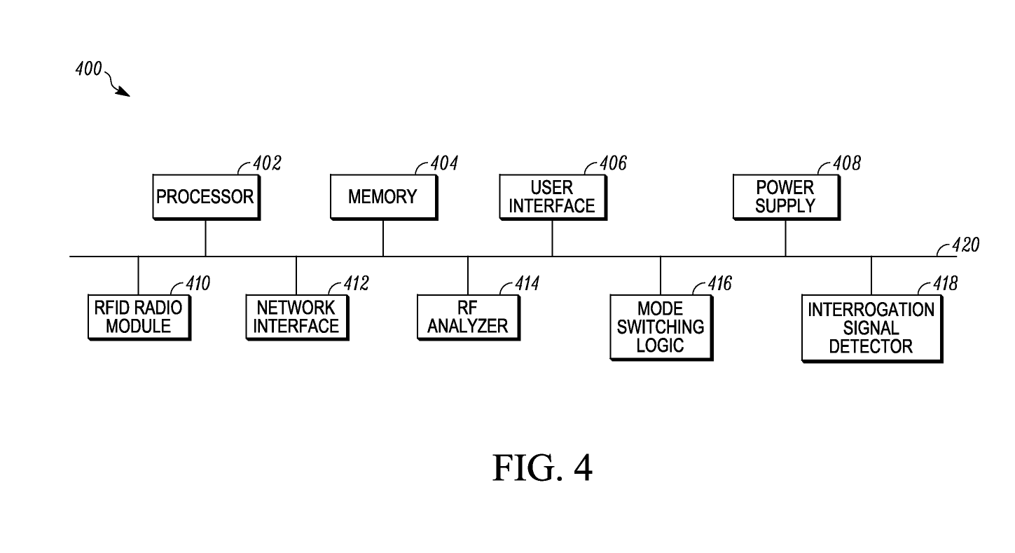

Turning now to FIG. 4, an exemplary embodiment of an RFID reader 400 will be described. This embodiment of the RFID reader 400 is suitably configured to switch between a traditional interrogate-and-read mode and a read-only mode. Accordingly, the read-only RFID devices 206, 208 (see FIG. 2) may employ some or all of the generalized architecture, features, and functionality of the RFID reader 400. For this example, the RFID reader 400 generally includes, without limitation: at least one processor 402; a suitable amount of memory 404; a user interface 406; a power supply 408; an RFID radio module 410; a network interface 412; an RF analyzer 414; mode switching logic 416; and an interrogation signal detector 418. Of course, a practical implementation of the RFID reader 400 will include other components and elements designed to carry out conventional operations that are unrelated to the described subject matter. The elements of the RFID reader 400 are coupled together as needed by a suitably configured interconnect architecture 420 that accommodates data transfer, control/command signals, supply voltages, etc.

The processor 402 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the mobile device functions described here. The processor 402 may be realized as a microprocessor, a controller, a microcontroller, or a state machine. Moreover, the processor 402 may be implemented as a combination of computing devices, e.g., a combination of a digital signal processor and a microprocessor, a plurality of microprocessors, one or more microprocessors in conjunction with a digital signal processor core, or any other such configuration.

The memory 404 may be realized as RAM memory, flash memory, EPROM memory, EEPROM memory, registers, a hard disk, a removable disk, a CD-ROM, or any other form of storage medium known in the art. In this regard, the memory 404 can be coupled to the processor 402 such that the processor 402 can read information from, and write information to, the memory 404. In the alternative, the memory 404 may be integral to the processor 402. As an example, the processor 402 and the memory 404 may reside in an ASIC.

The user interface 406 may include or be realized as one or more buttons, input/output elements, display elements, switches, or other features that enable the user to interact with the RFID reader 400. It should be appreciated that the user interface 406 is optional and that certain embodiments of the RFID reader 400 may include no user interface elements. When deployed, however, the user interface 406 can be manipulated as needed to control the operation of the RFID reader 400, to configure or initialize the RFID reader 400, to view or process RFID tag data, and/or to otherwise interact with components, applications, or data associated with the RFID reader 400.

The power supply 408 may be a disposable or rechargeable battery, a set of batteries, or a battery pack that is rated to provide the necessary voltage and energy to support the operation of the RFID reader 400. Alternatively or additionally, the power supply 408 may include or cooperate with a transformer, voltage regulator, and/or other component to receive power from an external source such as an ordinary AC outlet. The power supply 408 may be regulated in an appropriate manner to facilitate operation of the RFID reader 400 in the traditional interrogate-and-read mode or the read-only mode, as so desired. Moreover, the power supply 408 can be regulated to support a low power sleep mode, which is described in more detail below.

The RFID radio module 410 is suitably configured to support RFID interrogation (assuming that the RFID reader 400 is a multimode device) and RFID tag reading functions. In particular, the RFID radio module 410 are configured to support both operating modes (interrogate-and-read and read-only) as needed during operation of the RFID reader 400. Although not separately shown in FIG. 4, the RFID radio module 410 includes or cooperates with an appropriate antenna arrangement having at least one antenna element for transmitting RFID interrogation signals and for receiving tag response signals. Accordingly, the RFID radio module 410 may include a transceiver or radio element that generates RFID interrogation signals and receives reflected RFID signals generated by RFID tags in response to the interrogation signals. In the exemplary embodiment described herein, the RFID radio module 410 is designed to operate in the UHF frequency band designated for RFID systems. For example, in the United States, RFID systems may utilize the 902-928 MHz frequency band, and in Europe, RFID systems may utilize the 865-868 MHz frequency band.

The network interface 412 represents hardware, software, firmware, processing logic, and the like, that allows the RFID reader 400 to support data communication using one or more data communication networks (such as the network architecture 210 shown in FIG. 2). In this regard, the network interface 412 allows the RFID reader 400 to communicate with a centralized controller or server if needed. Depending upon the particular embodiment, the network interface 412 may also enable the RFID reader 400 to interact with WLAN infrastructure devices, a telecommunication network, a WAN such as the Internet, a LAN, or the like. To support data communication using non-wireless techniques, the network interface 412 may include or cooperate with appropriate hardware, such as a suitably configured and formatted data port, connector, jack, plug, receptacle, socket, adaptor, or the like.

In certain embodiments, the RF analyzer 414 analyzes one or more RF signal characteristics of tag response signals received by the RFID reader 400. Moreover, the RF analyzer 414 can be used to analyze one or more RF signal characteristics of interrogation signals (generated by interrogator devices other than the RFID reader 400 itself) received by the RFID reader 400. These RF signal characteristics may include, without limitation: power; received signal strength; phase information; and frequency or channel information. In certain embodiments, the RF analyzer 414 can be used to obtain received signal strength information associated with tag response signals. Alternatively or additionally, the RF analyzer 414 can be used to obtain a phase difference between a received interrogation signal and a received tag response signal. As described in more detail below, the received signal strength and/or the phase information can be used to determine the range or location of a target RFID tag.

The mode switching logic 416 may be implemented with or executed by the processor 402 for purposes of switching between operating modes of the RFID reader 400. For example, the processor 402 and the mode switching logic 416 may cooperate to control switching between a low power sleep mode, the active read-only mode, and the interrogate-and-read mode. These different operating modes are described in more detail below.

The interrogation signal detector 418 is utilized as a monitor while the RFID reader 400 is in the low power sleep mode. The interrogation signal detector 418 is suitably configured to detect the presence of an RFID interrogation signal generated by a remote interrogator device, i.e., a device other than the RFID reader 400. In practice, the interrogation signal detector 418 will utilize a sensor, detector, or RF receiver that does not rely on the normal operating power requirements of the RFID radio module 410. This feature allows the interrogation signal detector 418 to remain operational during sleeping periods when the RFID radio module 410 is disabled or is otherwise in a low power consumption mode. Accordingly, the interrogation signal detector might employ sensor or detector technology that differs from that used by the receiver of the RFID radio module 410.

In certain embodiments, the interrogation signal detector 418 leverages conventional RFID tag technology. Thus, the interrogation signal detector 418 could be realized using an active or an active-assist RFID tag, which might be attached or coupled to the RFID reader 400, affixed to the housing of the RFID reader 400, integrated with the RFID reader 400, contained within the housing of the RFID reader 400, or the like. In this regard, the interrogation signal detector 418 could respond to an RFID interrogation signal having a signal strength that might not be high enough to energize a tag for purposes of generating a tag response signal. Thus, an interrogation signal generated by a distant interrogator device, and having a relatively low signal strength, could still be detected by the interrogation signal detector 418. In response to the detection of an interrogation signal, the RFID reader 400 can leave the low power sleep mode, activate its RFID radio module 410, and enter the read-only mode.

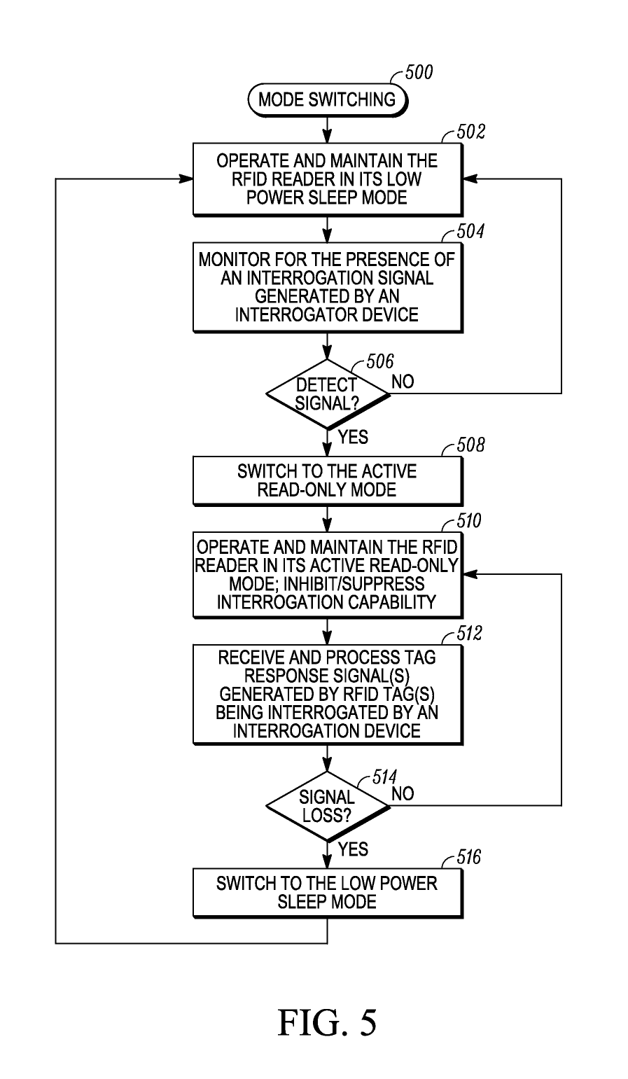

As mentioned above, the read-only RFID devices 206, 208 and the RFID reader 400 are preferably designed to support different operating modes, including a low power sleep mode, a read-only mode, and an interrogate-and-read mode. In certain implementations, the interrogator device 204 could also be designed to support different operating modes, including a low power sleep mode, a read-only mode, an interrogate-only mode, and an interrogate-and-read mode. In this regard, FIG. 5 is a flow chart that illustrates an exemplary mode switching process 500 that could be performed by an RFID reader. The various tasks performed in connection with a process described herein may be performed by software, hardware, firmware, or any combination thereof. For illustrative purposes, the following description of certain processes may refer to elements mentioned above in connection with FIGS. 2-4. In practice, portions of a described process may be performed by different elements of the described system, e.g., an interrogator device, a read-only RFID device, a controller, or the like. It should be appreciated that a described process may include any number of additional or alternative tasks, the tasks shown in the figures need not be performed in the illustrated order, and a described process may be incorporated into a more comprehensive procedure or process having additional functionality not described in detail herein. Moreover, one or more of the tasks shown in the figures could be omitted from an embodiment of a described process as long as the intended overall functionality remains intact.

Referring to FIG. 5, the process 500 assumes that the RFID reader device is initially being operated and maintained in its low power sleep mode (task 502). As explained above, while in the low power sleep mode, the RFID reader device does not interrogate tags and it does not consume the normal amount of power that would usually be associated with keeping its RFID radio module active. Accordingly, the RFID reader device can be maintained in the low power sleep mode during periods of inactivity. While operating in the low power sleep mode, the RFID reader device monitors for the presence of an interrogation signal that is generated by a remote interrogator device (task 504). If the process 500 detects an interrogation signal (query task 506), then it will initiate the switching of modes. More specifically, the RFID reader device will be switched from the low power sleep mode to an active read-only mode (task 508) in response to the detection of the interrogation signal. In practice, the normal RFID radio module of the RFID reader device will be powered up, activated, and otherwise prepared to receive tag response signals. Referring back to query task 506, if the process 500 does not detect an interrogation signal, then task 502 can be re-entered to continue operating in the low power sleep mode. Accordingly, the RFID reader device remains in its low power state until it detects an interrogation signal. In this regard, a detected interrogation signal serves as a trigger to activate the reading capabilities of the RFID reader device.

This description assumes that the RFID reader device is operated and maintained in the active read-only mode (task 510) so that it can receive tag response signals generated by RFID tags being interrogated by a different interrogator device. While in the read-only mode, the interrogation capability of the RFID reader device is inhibited, disabled, or suppressed. This ensures that the RFID reader device devotes its reading abilities and resources for purposes of receiving and processing tag response signals that are generated by RFID tags being interrogated by a remotely located interrogation device (task 512). For this example, the interrogation signal detected at query task 506 is the same interrogation signal that is responsible for generating the tag response signals received at task 512. In other words, the interrogation signal used to interrogate one or more target RFID tags is detected at the read-only RFID device, which then switches to the read-only mode such that it can read the tag responses generated by the target RFID tags.

While operating in the active read-only mode, the RFID reader device continues to monitor for the presence of the interrogation signal. If the process 500 detects loss of the interrogation signal (query task 514), then it will initiate the switching of modes. More specifically, the RFID reader device will be switched from the active read-only mode to the low power sleep mode (task 516) in response to the loss of the interrogation signal. Thereafter, the RFID reader device can be operated and maintained in the low power sleep mode until another interrogation signal is detected.

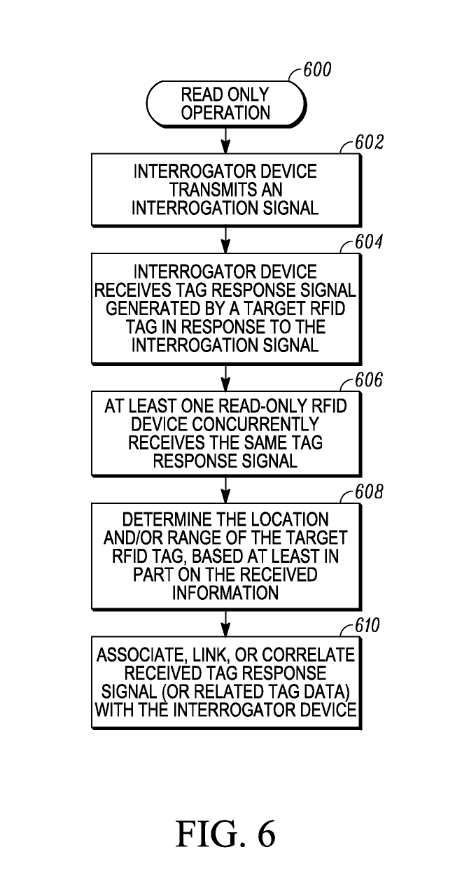

As mentioned briefly above, one or more read-only RFID devices can be utilized to provide read redundancy and/or to assist in locating interrogated tags. In this regard, FIG. 6 is a flow chart that illustrates an exemplary read-only operation process 600 that could be performed by an RFID system, such as the RFID system 200 depicted in FIG. 2. The process 600 assumes that the RFID system includes one or more read-only RFID devices, i.e., one or more RFID readers that are operating in the read-only mode. The process 600 also assumes that a distinct interrogator device (i.e., a device other than the read-only RFID devices) generates and transmits an interrogation signal to interrogate at least one RFID tag (task 602). Thus, the interrogator device interrogates the RFID tags within its respective interrogation range. This example assumes that at least one target RFID tag is within the interrogation range of the interrogator device. For simplicity, the following description refers to only one target RFID tag and the processing of its tag response signal. In practice, however, an interrogation signal could reach and energize any number of different RFID tags, and each interrogated tag could generate a respective tag response signal as a result of the common interrogation signal. Those of ordinary skill in the art should easily understand how the process 600 can be extended to a plurality of interrogated tags rather than only one.

This description assumes that the interrogator device receives the tag response signal generated by a target RFID tag (task 604). In other words, the interrogator device operates in the traditional interrogate-and-read mode. In addition, at least one distinct and physically separate read-only RFID device concurrently receives the same tag response signal (task 606). Thus, if three read-only RFID devices are within reading range of the target RFID tag, then the tag response signal will normally be independently and simultaneously read by four different and distinct devices: the interrogator device and each of the three read-only RFID devices. Notably, such concurrent/simultaneous reading of the tag response signal is accomplished without having to interrogate the target RFID tag multiple times in sequence. Instead, the target RFID tag is interrogated once and each of the various devices receive its own respective “version” of the same tag response signal.

The tag data conveyed by the tag response signal can be processed and otherwise handled as so desired. For example, the interrogator device and the read-only RFID devices could send the tag data (and/or other information associated with or derived from the tag response signal) to an RFID system controller for centralized processing and handling. As another example, the interrogator device and the read-only RFID devices could perform some processing of the tag data before sending it to an RFID system controller. As yet another example, the interrogator device and the read-only RFID devices could handle the processing of the tag data (independently or in a distributed manner) without involving a centralized controller or server.

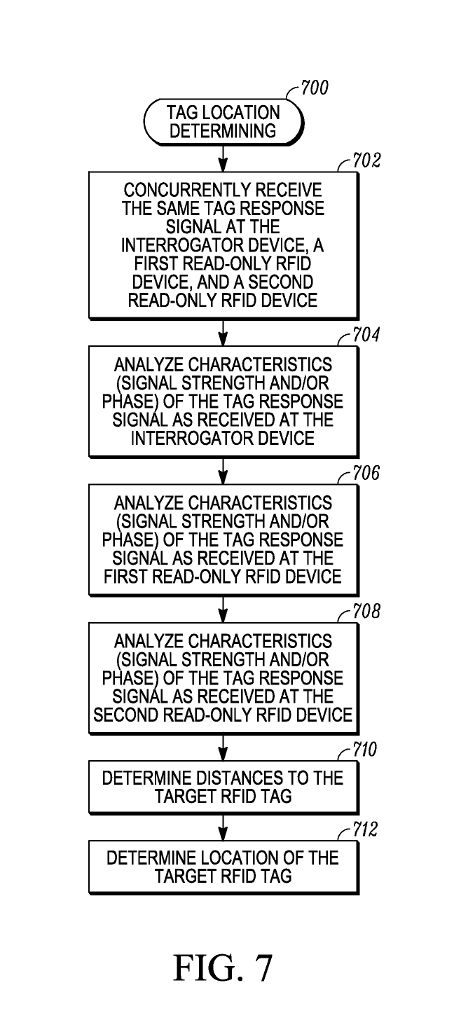

This embodiment of the process 600 continues by determining a location of the target RFID tag and/or a distance (range) between the target RFID tag and one of the devices in the RFID system (task 608). Notably, the location/distance is determined based at least in part on information conveyed by or otherwise associated with the received tag response signal. In other words, the location/distance is determined based at least in part on information associated with the tag response signal as received at the interrogator device, and/or as received at each of the read-only RFID devices. Task 608 may be executed at a centralized controller or server, at the interrogator device, and/or at the read-only RFID devices. An exemplary process for determining tag location is described below with reference to FIG. 7.

In certain embodiments, it may be desirable for the process 600 to associate, link, or otherwise correlate the received tag response signal (or the related tag data) with the interrogator device (task 610). Such correlation could be performed by a centralized RFID system controller or server. A received tag response signal could be correlated to an interrogation signal using, for example, time stamp data that indicates when the tag response signal was received. In this regard, the time stamp data could be compared to an interrogation time or interrogation time window corresponding to a particular interrogation signal. This approach is feasible in systems that generate only one interrogation signal at a time, and this approach assumes that the system has the intelligence to be aware of which interrogator device is active at any given time. In advanced RFID systems that support concurrent interrogation by multiple interrogation devices, however, more sophisticated techniques may be implemented to determine the relationship between received tag data and its interrogator device. For example, correlation of tag response signals could rely on an indication of the interrogating channel or frequency used by each interrogator device. Thus, tag response data from read-only RFID devices operating on an identified channel can be correlated to the particular interrogator device that interrogated the tags using that identified channel.

FIG. 7 is a flow chart that illustrates an exemplary tag location determining process 700 that could be performed by an RFID system. The process 700 could be performed in conjunction with the process 600 (see, for example, task 608). The process 700 concurrently receives the same tag response signal at an interrogator device, a first read-only RFID device, and a second read-only RFID device (task 702). The process 700 continues by analyzing certain characteristics of the tag response signal as received at the interrogator device (task 704). For this example, the analyzed characteristics may include or be associated with the received signal strength of the tag response signal (as measured by the interrogator device). As another example, the analyzed characteristics may include or be associated with a phase difference between the interrogation signal and the tag response signal as received at the interrogator device. Task 704 may be performed by the interrogator device and/or by a centralized RFID system controller, depending upon the system deployment. Characteristics of the tag response signal as received at the first read-only RFID device are also analyzed (task 706). Task 706 may be performed by the first read-only RFID device and/or by a centralized RFID system controller, depending upon the system deployment. Similarly, characteristics of the tag response signal as received at the second read-only RFID device are analyzed (task 708). Task 708 may be performed by the second read-only RFID device and/or by a centralized RFID system controller, depending upon the system deployment.

The analyzed characteristics of the tag response signal represent information that is used to determine or estimate the location of the target RFID tag. For example, the process 700 can determine distances from the various components to the target RFID tag (task 710). More specifically, the process 700 determines the distance between the target RFID tag and the interrogator device, the distance between the target RFID tag and the first read-only RFID device, and the distance between the target RFID tag and the second read-only RFID device. These distances may be determined from the received signal strength information and/or from the phase difference measurements. The process 700 may continue by determining or calculating the location of the target RFID tag (task 712). For this example, the location of the target RFID tag is determined using one or more of the distances calculated at task 710. The determined location could be an absolute location if the components of the RFID system are fixed and in known positions. Alternatively, the determined location could be relative to one or more of the components of the RFID system at the time of interrogation and reading. Depending upon the embodiment, tasks 710 and 712 could be performed by the RFID system controller, by the interrogator device, and/or by one or both of the read-only RFID devices. Moreover, task 712 may utilize any suitable technique, algorithm, or methodology to determine the location of the target RFID tag. For example, the use of three or more reading devices may be desirable to allow triangulation-based location calculations.

The process 700 represents one implementation of a relatively accurate and precise technique for determining the absolute or relative location of a target RFID tag. The RFID system described herein can also be utilized to estimate a “rough” location of a target RFID tag, based on the known locations of the interrogator device and the read-only RFID devices, and based on the known or assumed reading ranges of the system devices. Referring again to FIG. 3 as an example, assume that the RFID reader 302 and the read-only RFID device 304 are both fixed devices in known locations. Assume further that the approximate interrogate/read range of the RFID reader 302 is known, the approximate read range of the read-only RFID device 304 is known, and the approximate shape and topography of the ranges are known. If the RFID tags 310 are successfully read by both the RFID reader 302 and the read-only RFID device 304, then the RFID system 300 can safely assume that the RFID tags 310 must be located somewhere within the zone where the read ranges intersect or overlap. Thus, if additional read-only RFID devices are deployed in the RFID system 300, then the location of a target RFID tag can be resolved with greater certainty and precision (assuming that additional overlapping of read zones occurs). This type of rough estimate is feasible due to the extended read-only range of the read-only RFID devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a radio frequency identification (RFID) reader device, the method comprising:
operating the RFID reader device in a read-only mode;
receiving a tag response signal generated from an RFID tag being interrogated by an interrogator device that is distinct and separate from the RFID reader device, wherein receiving the tag response signal is performed by the RFID reader device while it is operating in the read-only mode; and
determining a location of the RFID tag, wherein the location is determined based at least in part on information associated with the received tag response signal.

2. The method of claim 1, further comprising correlating the received tag response signal with the interrogator device.

3. The method of claim 1, further comprising determining a distance between the RFID tag and the RFID reader device, wherein the distance is determined based at least in part on the information associated with the received tag response signal.

4. The method of claim 1, wherein the interrogator device interrogates the RFID tag with an interrogation signal; and the location is determined based at least in part on a phase difference between the interrogation signal and the received tag response signal.

5. The method of claim 1, wherein the location is determined based at least in part on signal strength of the received tag response signal.

6. The method of claim 1, further comprising:
maintaining the RFID reader device in a low power sleep mode;
detecting, with the RFID reader device, an interrogation signal generated by the interrogator device; and
switching the RFID reader device from the low power sleep mode to the read-only mode in response to detecting the interrogation signal, wherein receiving the tag response signal is performed while the RFID reader device is in the read-only mode.

7. The method of claim 6, further comprising:
maintaining the RFID reader device in the read-only mode;
detecting, with the RFID reader device, loss of the interrogation signal; and
switching the RFID reader device from the read-only mode to the low power sleep mode in response to detecting loss of the interrogation signal.

8. The method of claim 6, wherein the interrogator device interrogates the RFID tag with the interrogation signal.

9. The method of claim 1, further comprising receiving the tag response signal at a second RFID reader device that is distinct and separate from both the interrogator device and the RFID reader device, wherein:
receiving the tag response signal at the second RFID reader device occurs concurrently with receiving the tag response signal at the RFID reader device; and
the location of the RFID tag is determined based at least in part on information associated with the tag response signal as received at the RFID reader device, and information associated with the tag response signal as received at the second RFID reader device.

10. The method of claim 9, further comprising receiving the tag response signal at the interrogator device, wherein:
receiving the tag response signal at the interrogator device occurs concurrently with receiving the tag response signal at the RFID reader device and concurrently with receiving the tag response signal at the second RFID reader device; and
the location of the RFID tag is determined based at least in part on information associated with the tag response signal as received at the RFID reader device, information associated with the tag response signal as received at the second RFID reader device, and information associated with the tag response signal as received at the interrogator device.

11. The method of claim 9, further comprising operating the second RFID reader device as a read-only RFID reader device, wherein receiving the tag response signal at the second RFID reader device occurs while operating the second RFID reader device as a read-only RFID reader device.

12. A radio frequency identification (RFID) reader device comprising:
an RFID radio module configured to support both an interrogate-and-read mode and a read-only mode; and
a processor operatively associated with the RFID radio module to control switching between the interrogate-and-read mode and the read-only mode,
wherein, while operating in the read-only mode, the RFID radio module receives a tag response signal generated by an RFID tag being interrogated by an interrogator device other than the RFID reader device.

13. The RFID reader device of claim 12, wherein the interrogator device is physically distinct, separate, and remote from the RFID reader device.

14. The RFID reader device of claim 12, wherein:
the processor maintains the RFID reader device in a low power sleep mode during periods of inactivity;
the RFID radio module detects an interrogation signal generated by the interrogator device; and
the processor switches the RFID reader device from the low power sleep mode to the read-only mode in response to detecting the interrogation signal.

15. The RFID reader device of claim 14, wherein:
during operation of the RFID reader device in the read-only mode, the RFID radio module detects loss of the interrogation signal; and
the processor switches the RFID reader device from the read-only mode to the low power sleep mode in response to detecting loss of the interrogation signal.

16. A method of operating a radio frequency identification (RFID) system having an interrogator device and a read-only RFID reader device, the method comprising:
transmitting an interrogation signal from the interrogator device; and
concurrently receiving, at both the interrogator device and the read-only RFID reader device, a tag response signal generated by an RFID tag in response to the interrogation signal.

17. The method of claim 16, further comprising:
analyzing the tag response signal as received at the interrogator device to determine a first distance between the RFID tag and the interrogator device;
analyzing the tag response signal as received at the read-only RFID reader device to determine a second distance between the RFID tag and the read-only RFID reader device; and
determining a location of the RFID tag based at least in part on the first distance and the second distance.

18. The method of claim 16, further comprising:
maintaining the read-only RFID reader device in a low power sleep mode;
detecting the interrogation signal with the read-only RFID reader device while the read-only RFID reader device is operating in the low power sleep mode; and
switching the read-only RFID reader device from the low power sleep mode to the read-only mode in response to detecting the interrogation signal, wherein receiving the tag response signal at the read-only RFID reader device is performed while the read-only RFID reader device is in the read-only mode.

19. The method of claim 18, further comprising:
during operation of the read-only RFID reader device in the read-only mode, detecting loss of the interrogation signal; and
switching the read-only RFID reader device from the read-only mode to the low power sleep mode in response to detecting loss of the interrogation signal.

20. The method of claim 16, wherein:
the RFID system includes a second read-only RFID reader device; and
the tag response signal is concurrently received at the interrogator device, the read-only RFID reader device, and the second read-only RFID reader device.

21. The method of claim 20, further comprising:
analyzing the tag response signal as received at the interrogator device to determine a first distance between the RFID tag and the interrogator device;
analyzing the tag response signal as received at the read-only RFID reader device to determine a second distance between the RFID tag and the read-only RFID reader device;
analyzing the tag response signal as received at the second read-only RFID reader device to determine a third distance between the RFID tag and the second read-only RFID reader device; and
determining a location of the RFID tag based at least in part on the first distance, the second distance, and the third distance.
